(19) United States
(12) Patent Application Publication
(10) Pub. No.: US 2004/0186686 A1
(43) Pub. Date: Sep. 23, 2004

(54) Method and apparatus for testing a product

(76) Inventor: Eddy Sun-How Hsia, Laguna Niguel, CA (US)

Correspondence Address: QUALCOMM Incorporated, Attn: Patent Department, 5775 Morehouse Drive, San Diego, CA, 92121-1714, US

(21) Appl. No.: 10/392,445

(22) Filed: Mar. 17, 2003

(51) Int. Cl. G06F 17/00

(52) U.S. Cl. 702/185

(57) ABSTRACT

Methods and apparatus for performing a test on a product include applying a test on the product according to a set of test cases stored in a database. The method also includes designating a field in the database that the defect needs to be resolved, if the test indicates a defect in the product, and designating the field in the database that the defect is successfully resolved. The method also includes reporting the defect as a test case in the database.

### FIELD

The present invention relates to quality control of an article of manufacture. More specifically, the present invention relates to methods and apparatus for providing test cases, defects, and tracking information in a single entity.

### BACKGROUND

A product may be tested for quality assurance according to a set of test cases, usually stored in a test case database. If the test indicates that that product has a defect, the defect is tracked in a separate defect-tracking database. However, to reproduce the test cases for repairing the defect and retesting the repaired product, the test cases need to be reentered in the defect-tracking database. Further, some defects reported in the defect-tracking database, such as customer-reported defects, may not be applied in testing future versions of the product, because such defects may not have been properly reported in the test case database. Keeping the two databases updated and consistent is time consuming, is prone to inconsistency and error, and requires duplicate effort.

There is a need, therefore, for a single entity for automatically storing test cases, defects, and tracking information.

### SUMMARY

The disclosed embodiments provide novel and improved methods and apparatus for performing a test on a product. The method comprises applying a test on a product according to a set of test cases stored in a database and, if the test indicates a defect in the product, designating a field in the database that the defect needs to be resolved. After the defect is successfully resolved, the method includes designating the field in the database accordingly, and reporting the defects as test cases in the database.

### BRIEF DESCRIPTION OF THE DRAWINGS

The features and advantages of the present invention will become more apparent from the detailed description of disclosed embodiments set forth below when taken in conjunction with the drawings, and wherein:

FIG. 1 illustrates a scenario when a product is tested and a defect is active;

FIG. 2 illustrates a scenario when the defect is resolved;

FIG. 3 illustrates a scenario when the product is retested and defect is closed;

FIG. 4 illustrates a flow chart for testing and defect tracking; and

FIG. 5 illustrates one embodiment of an apparatus for testing a product.

### DETAILED DESCRIPTION

Before several embodiments are explained in detail, it is to be understood that the scope of the invention should not be limited to the details of the construction and the arrangement of the components set forth in the following description or illustrated in the drawings. Also, it is to be understood that the phraseology and terminology used herein is for the purpose of description and should not be regarded as limiting.

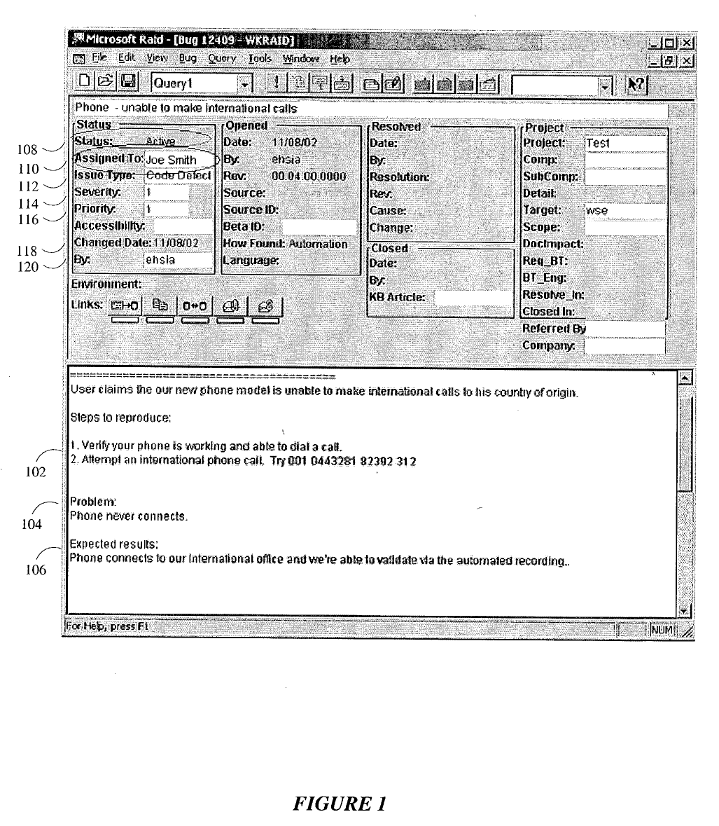

FIG. 1 illustrates a scenario when a product is tested and a defect is found, according to one embodiment. In this example, a new product, e.g., a new phone, is tested for placing an international call, according to a test case or a set of test procedures 102 provided in a database, for example. Test cases 102 may be based on past experiences of testing earlier versions of the current product. Test cases 102 may also be based on customer-reported defects. Assuming the new product fails the test, the defect 104 is entered in the same database for defect tracking purposes. The defective product is then assigned to an entity to resolve the reported defect so that the product is repaired and the expected result 106 is obtained.

FIG. 1 shows a user-interface including a field indicating the status 108 of the defect, which may be “active,” when the defect needs to resolved, “resolved,” when the defect is resolved but the repaired product is not yet retested, and “fixed,” when the defect is resolved and the repaired product is retested. Field 110 indicates to whom the product is assigned for repair, e.g., Joe Smith. Field 112 indicates the reason(s) for assigning the product, e.g., “code defect” indicating the product has a defect. Field 114 indicates the severity of the defect, and field 116 indicates the priority of resolving the defect. Field 118 indicates when any of the fields is changed, and field 120 indicates who did such a change. FIG. 1 shows information about the test cases and defects, in the lower portion of the user interface, as well as information about tracking the defects, in the upper portion of the user interface.

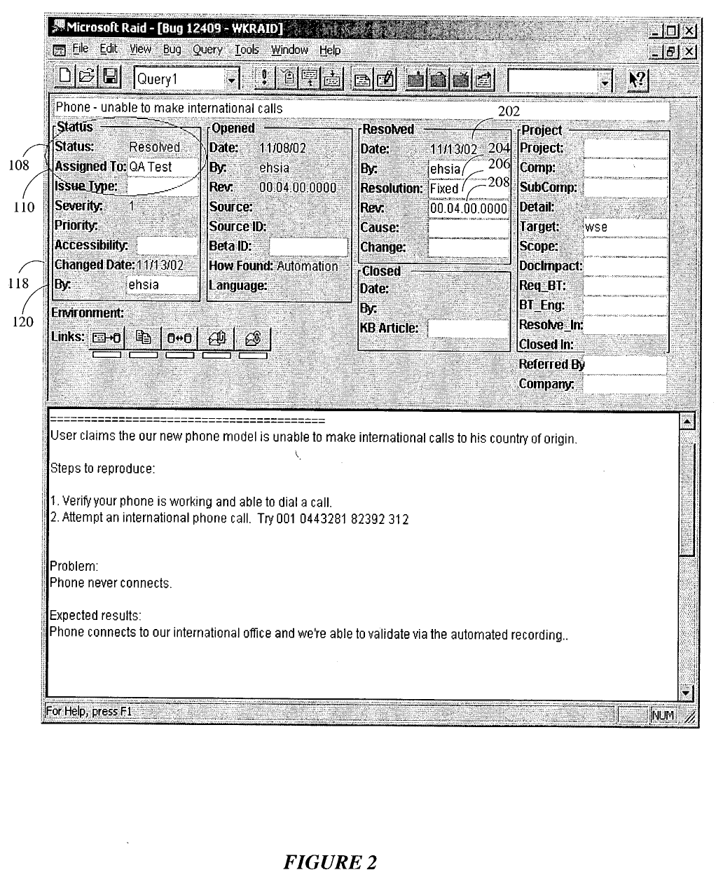

FIG. 2 illustrates a scenario when the defect is resolved, according to one embodiment. Accordingly, the status field 108 is changed to “resolved,” indicating that the defect is resolved. Field 110 is also changed to indicate that the repaired product is assigned to quality assurance (QA) for retesting the product and making sure that the defect is actually resolved. Fields 118 and 120 may need to be changed to reflect the date when any of the above fields is changed.

FIG. 2 shows fields indicating information entered by the person who resolved the defect. Filed 202 indicates the date when the defect was resolved. Field 204 indicates who resolved the defect. Field 206 indicates that the problem was fixed. Field 208 indicates the revision of the product that was repaired. FIG. 2 also shows information about the test cases and defects, in the lower portion of the user interface, as well as information about tracking a defect, in the upper portion of the user interface.

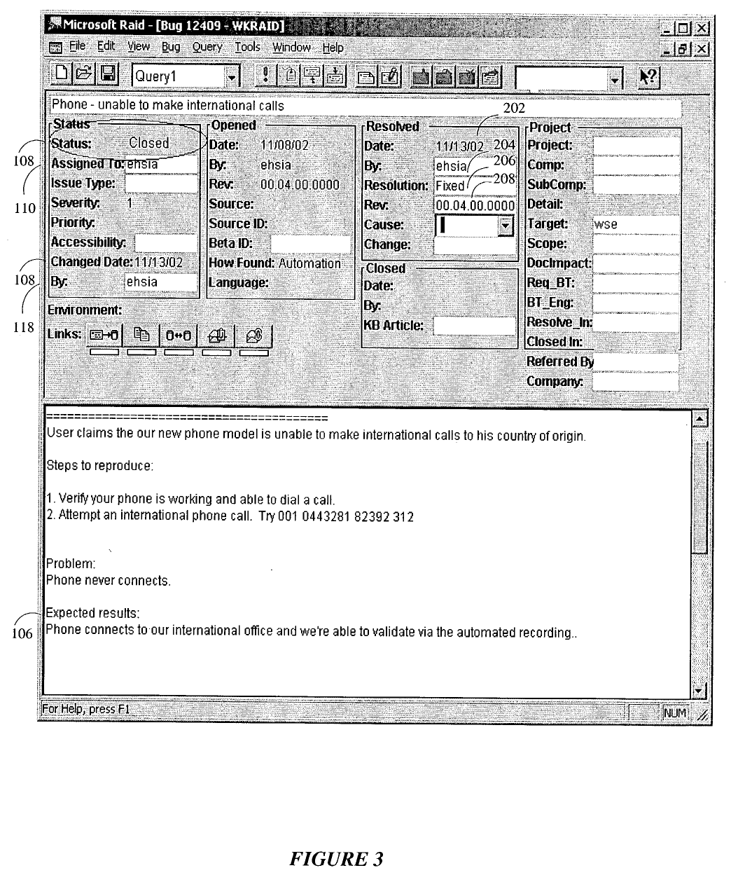

FIG. 3 illustrates a scenario when the defect is actually resolved, the product is retested, and the expected result indicated by field 106 is verified, according to one embodiment. Accordingly, the status field 108 is changed to “closed,” indicating that the defect is finally resolved. Field 110 is also changed to indicate the person who retested the repaired product. Fields 118 and 120 may also need to be changed to reflect the date when any of the above fields is changed. FIG. 3 also shows fields 202, 204, 206, 208 indicating information entered by the person who resolved the defect. FIG. 3 still shows information about the test cases and defects, in the lower portion of the user interface, as well as information about tracking a defect, in the upper portion of the user interface.

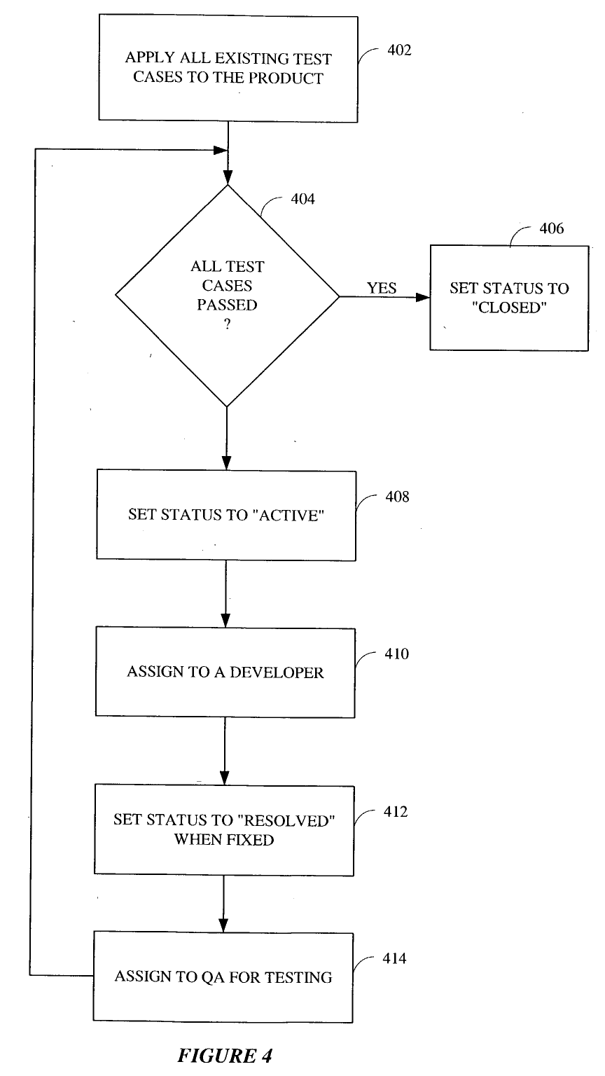

FIG. 4 illustrates a flow chart for performing a unified testing and defect tracking, as discussed above. After a product is tested against all existing test cases, in step 402, if no defect is found, in step 404, the status field is set to “closed,” in step 406, indicating that the product has successfully passed all the test cases and it is free of any defect. The test case is then closed and kept in the database for testing future versions of the product. However, if a defect is found in the product, in step 404, the status field is set to “active,” in step 408, indicating that the product needs to be repaired and the defect needs to be resolved. The product is then assigned to a developer for repair, in step 410. After the defect is fixed, the status field is set to “resolved,” in step 412, and the product is assigned to quality assurance for retesting, in step 414. The process continues until all defects are finally repaired and the status fields changed to “closed,” for all defects.

The detected defects are reported in the database as test cases for testing future versions or updates of the product. Upon testing a new release of the product, the previously detected and reported defects are re-opened as test cases, which are applied in testing the new versions of the product. New test cases, which include defects reported by customers and/or users of the product, may also be entered in the database for future testing.

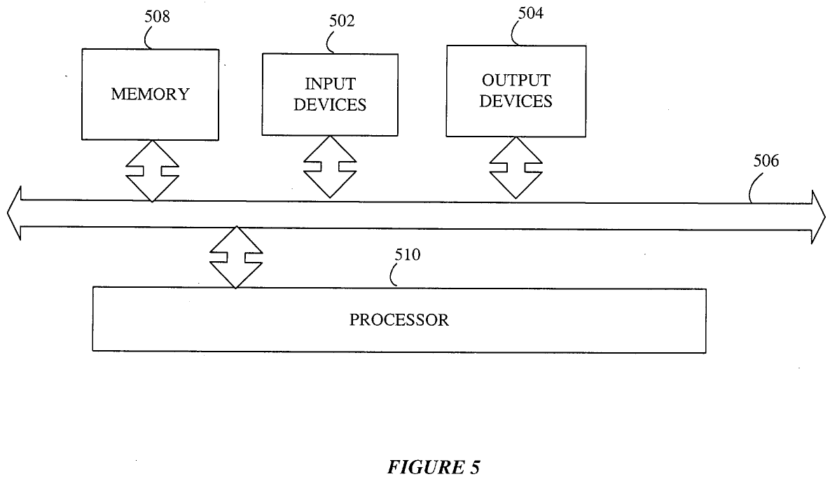

FIG. 5 illustrates one embodiment of an apparatus for testing a product. The apparatus includes input devices 502 and a output devices 504. Communication bus 506 provides a common connection among other modules in FIG. 5. Communication bus 506 is further coupled to memory unit 508. Memory unit 508 stores computer readable instructions for a variety of operations and functions performed by the apparatus for testing a product. The processor 510 performs the instructions stored in memory unit 508.

Therefore, the disclosed embodiments provide for an efficient and reliable system and method for providing information about test cases and defect tracking in a single database, and presenting the results also in a single user interface.

Those of skill in the art would understand that information and signals may be represented using any of a variety of different technologies and protocols. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed embodiments is provided to enable any person skilled in the art to make or use the present invention. Various modifications to these embodiments may be readily apparent to those skilled in the art, and the generic principles defined herein may be applied to other embodiments, e.g., in an instant messaging service or any general wireless data communication applications, without departing from the spirit or scope of the invention. Thus, the present invention is not intended to be limited to the embodiments shown herein but is to be accorded the widest scope consistent with the principles and novel features disclosed herein. The word “exemplary” is used exclusively herein to mean “serving as an example, instance, or illustration.”

1. A method for performing a test on a product, the method comprising:
applying a test on a product according to a set of test cases stored in a database;
if the test indicates a defect in the product, designating a field in the database that the defect needs to be resolved; and
after the defect is successfully resolved, designating the field in the database accordingly.

2. The method of claim 1, wherein the field includes a status field.

3. The method of claim 2, wherein the status field includes one of active, resolved, or fixed.

4. The method of claim 1, wherein the field includes information that the product is assigned to a party for repair.

5. The method of claim 1, wherein the field includes information about severity of the defect.

6. The method of claim 1, wherein the field includes information about priority of the defect.

7. The method of claim 1, wherein the field includes information about a party who performed the test.

8. The method of claim 1, wherein the field includes information about a date of the test.

9. The method of claim 1, wherein the field includes information about a revision of the product.

10. The method of claim 1, wherein the field includes information about a date the defect was resolved.

11. The method of claim 1, wherein the field includes information about a party who resolved the defect.

12. The method of claim 1, further including reporting the defect in the database as a test case.

13. The method of claim 1, further including reporting a customer-reported defect in the database as a test case.

14. A computer-readable medium embodying a method for performing a test on a product, the method comprising:
applying a test on a product according to a set of test cases stored in a database;
if the test indicates a defect in the product, designating a field in the database that the defect needs to be resolved; and
after the defect is successfully resolved, designating the field in the database accordingly.

15. The computer-readable medium of claim 14, wherein the field includes a status field.

16. The computer-readable medium of claim 14, wherein the status field includes one of active, resolved, or fixed.

17. The computer-readable medium of claim 14, wherein the field includes information that the product is assigned to a party for repair.

18. The computer-readable medium of claim 14, wherein the field includes information about severity of the defect.

19. The computer-readable medium of claim 14, wherein the field includes information about priority of the defect.

20. The computer-readable medium of claim 14, wherein the field includes information about a party who performed the test.

21. The computer-readable medium of claim 14, wherein the field includes information about a date of the test.

22. The computer-readable medium of claim 14, wherein the field includes information about a revision of the product.

23. The computer-readable medium of claim 14, wherein the field includes information about a date the defect was resolved.

24. The computer-readable medium of claim 14, wherein the field includes information about a party who resolved the defect.

25. The computer-readable medium of claim 14, the method further including reporting the defect in the database as a test case.

26. The computer-readable medium of claim 14, the method further including reporting a customer-reported defect in the database as a test case.

27. An apparatus for performing a test on a product, comprising:
means for applying a test on a product according to a set of test cases stored in a database;
means for designating a field in the database that the defect needs to be resolved, if the test indicates a defect in the product; and
means for designating the field in the database, indicating that the defect is successfully resolved.

28. The apparatus of claim 27, wherein the field includes a status field.

29. The apparatus of claim 27, wherein the status field includes one of active, resolved, or fixed.

30. The apparatus of claim 27, wherein the field includes information that the product is assigned to a party for repair.

31. The apparatus of claim 27, wherein the field includes information about severity of the defect.

32. The apparatus of claim 27, wherein the field includes information about priority of the defect.

33. The apparatus of claim 27, wherein the field includes information about a party who performed the test.

34. The apparatus of claim 27, wherein the field includes information about a date of the test.

35. The apparatus of claim 27, wherein the field includes information about a revision of the product.

36. The apparatus of claim 27, wherein the field includes information about a date the defect was resolved.

37. The apparatus of claim 27, wherein the field includes information about a party who resolved the defect.

38. The apparatus of claim 27, further including means for reporting the defect in the database as a test case.

39. The apparatus of claim 27, further including means for reporting a customer-reported defect in the database as a test case.

40. A method for performing a test on a product, the method comprising:
applying a test on a product according to a set of test cases stored in a database; and
if the test indicates a defect, reporting the defect as a test case in the database.

41. A method for performing a test on a product, the method comprising:
applying a test on a product according to a set of test cases stored in a database;
if the test fails, designating a field in the database that the product needs to be repaired;
reporting the defect as a test case in the database;
repairing the product according a set of repair procedures stored in the database; and
after the product is successfully repaired, designating the field in the database accordingly.

42. A method for providing test information for a product, the method comprising:
providing a set of test cases for testing a product; and
providing a set of fields for tracking a result of said testing, wherein the set of the test cases and the set of fields are provided in one entity.
